(19) United States
(12) Patent Application Publication
(10) Pub. No.: US 2011/0244160 A1
(43) Pub. Date: Oct. 6, 2011

(54) ADHESIVE TAPE OR SHEET WITH RELEASE LINER

(75) Inventors: Shigeki ISHIGURO, Ibaraki-shi (JP); Takumi Yutou, Ibaraki-shi (JP); Hiroki Senda, Ibaraki-shi (JP); Masamichi Matsumoto, Ibaraki-shi (JP); Kenichi Nishijima, Ibaraki-shi (JP); Ryoko Asai, Ibaraki-shi (JP); Yuka Sekiguchi, Ibaraki-shi (JP); Yuji Okawa, Ibaraki-shi (JP); Michihito Ooishi, Ibaraki-shi (JP); Toshimasa Sugimura, Ibaraki-shi (JP)

(73) Assignee: NITTO DENKO CORPORATION, Osaka (JP)

(21) Appl. No.: 13/074,362

(22) Filed: Mar. 29, 2011

(30) Foreign Application Priority Data
Mar. 30, 2010 (JP) 2010-079501

(51) Int. Cl. C09J 7/02; B32B 27/00

(52) U.S. Cl. 428/41.4; 428/41.8; 428/41.3; 428/41.5

(57) ABSTRACT

An adhesive tape or sheet with a release liner has; a thermoplastic resin film, a pressure sensitive adhesive layer formed on one side of the thermoplastic resin film, and a release liner positioned on one side of the pressure sensitive adhesive layer, a fatty acid bisamide as well as a fatty acid monoamide and/or fatty acid are contained at least one of the thermoplastic resin film and the pressure sensitive adhesive layer.

### CROSS-REFERENCE TO RELATED APPLICATIONS

This application claims priority to Japanese Patent Application No. 2010-079501 filed on 30 Mar., 2010. The entire disclosure of Japanese Patent Application No. 2010-079501 is hereby incorporated herein by reference.

### BACKGROUND OF THE INVENTION

1. Field of the Invention

The present invention relates to an adhesive tape or sheet with a release liner, and more particularly, relates to a re-peelable adhesive tape or sheet with a release liner.

2. Background Information

Control of the adhesive force with respect to a releasable adherend and the unwinding force from a roll configuration is extremely difficult in relation to an adhesive tape or a roll-shaped product in which a sheet is rolled.

Consequently, unwinding even of a wide sheet can be facilitated by providing a release liner on the adhesive surface of the adhesive sheet or tape. This configuration with the release liner has the additional effect of eliminating deformation due to peeling of the tape base during unwinding, and enables a conspicuous improvement in handling characteristics during use.

Control of the adhesive force with respect to a peelable adherend can be enabled by use of a low adhesive strength adhesive. However, it is known that after adhering to a highly polar adherend, there is a tendency for adhesive strength to increase over time.

In this context, it has been proposed to adjust control of the adhesive force with respect to a peelable adherend by addition of a fatty acid amide or a urea compound to the tape base or the adhesive (for example, JP S57-139163-A, JP S59-111840-A and JP H07-276516-A).

Use of these methods suppresses an increase in the adhesive force over time under normal storage conditions. Furthermore, control of the adhesive force with respect to a peelable adherend and the release characteristics of a wide sheet is enabled by provision of a release liner on the adhesive tape or sheet that uses the above methods.

However, depending on the storage conditions of the adhesive tape or sheet, there is the disadvantage that a sufficient adhesive force is not obtained in relation to an adhesive tape from which a release liner has been peeled.

Furthermore, depending on the storage conditions after adhesion onto an adherend, when attempting release from the adherend on a subsequent occasion, the problem may arise that an increase in the adhesive force may make peeling difficult, or residual adhesive may be present on the adherend.

### SUMMARY OF THE INVENTION

The present invention is proposed in light of the above circumstances, and has the object of providing an adhesive tape or sheet provided with a release liner that enables release performance and adhesive characteristics that are stable under a variety of environments.

The present inventors conducted diligent research into an adhesive tape or sheet provided with a release liner as described above based on the fact that problems arise in relation to the adhesive force or release performance of an adhesive tape when an adhesive tape or sheet provided with a release liner (hereinafter simply referred to as “adhesive tape”) is subjected to high-temperature conditions due to standing outdoors during transportation of the adhesive tape, or during high-temperature processing or standing in a high-temperature state when the adhesive tape is attached to an adherend such as a metal plate or the like.

As a result, although a fatty acid bisamide that is commonly used in this type of adhesive tape is stable at room temperature, when the temperature increases to approximately 60° C., it was confirmed that there is a tendency for the bisamide to migrate within the thermoplastic resin film or the adhesive layer, and for the concentration of the bisamide to increase in proximity to the interface between the adhesive layer and the release liner. Therefore the inventors had the new insight that addition of a specific added component was effective in order to improve the stability of the fatty acid bisamide in the thermoplastic resin film or the adhesive layer. In this manner, the invention was completed by ensuring the stability of the fatty acid bisamide.

The present invention provides an adhesive tape or sheet with a release liner having; a thermoplastic resin film, a pressure sensitive adhesive layer formed on one side of the thermoplastic resin film, and a release liner positioned on one side of the pressure sensitive adhesive layer, a fatty acid bisamide as well as a fatty acid monoamide and/or fatty acid are contained at least one of the thermoplastic resin film and the pressure sensitive adhesive layer.

According to the present invention, an adhesive tape or sheet provided with a release liner that enables release performance and adhesive characteristics that are stable under a variety of environments can be achieved.

### DETAILED DESCRIPTION OF THE PREFERRED EMBODIMENTS

The adhesive tape or sheet provided with a release liner according to the present invention is formed by thermoplastic resin film and a pressure sensitive adhesive layer formed on one side with the thermoplastic resin film, and a release liner disposed on one side of the pressure sensitive adhesive layer. This adhesive tape is such that the release liner is placed in contact with the pressure sensitive adhesive layer immediately prior to use irrespective of the size of the tape.

### (Thermoplastic Resin Film)

There is no particular limitation in relation to the thermoplastic resin film of the present invention, and for example, a film made of polyolefins such as low-density polyethylene, linear polyethylene, medium-density polyethylene, high-density polyethylene, very low-density polyethylene, random copolypropylene, block copolypropylene, homopolypropylene, polybutene, polymethylpentene; polyolefin-base resin such as ethylene-vinyl acetate copolymer, ionomer resin, ethylene-(meth)acrylic acid copolymer, ethylene-(meth)acrylic ester (random, alternating) copolymer, ethylene-butene copolymer, ethylene-hexene copolymer; polyester-base resin such as polyurethane, polyethylene terephthalate, polyethylene naphthalate; (meth)acrylic polymer, polystylene, polycarbonate, polyimide, polyamide, polyamideimide, polyetherimide, polysulfon, polyethersulfon, polyvinyl chloride-based resin, polyvinylidene chloride, fluorocarbon resin, cellulosic resin or cross-linked polymer thereof. The thermoplastic resin may be blended two or more as needed. Among these, polyvinyl chloride-based resin is preferable.

Examples of the polyvinyl chloride-based resin include polyvinyl chloride homopolymer, polyvinyl chloride copolymer, polyvinyl chloride graft copolymer, blended polymer of polyvinyl chloride and other resin.

Examples of a comonomer for polyvinyl chloride copolymer include, for example, vinyl ester such as vinyl acetate; vinyl ether such as ethyl vinyl ether; α-olefine such as ethylene, propylene, 1-butene; (meth)acrylate such as methyl acrylate, ethyl acrylate, methyl methacrylate, butyl methacrylate; polyvinylidene chloride.

The thermoplastic resin film preferably includes a plasticizing agent so that the resulting adhesive tape exhibits a suitable level of flexibility. In addition, an additive such as a stabilizer, a filler/lubricant, a colorant, a UV absorbing agent, an antioxidant, or the like may be added as required.

There is no particular limitation in relation to the plasticizing agent, and for example, phthalates, trimellitates (trioctyl trimellitate, W-700, DIC corpolation), adipates (dioctyl adipate, diisononyl adipate, D-620, J-PLUS Co., Ltd.), phosphates (tricresyl phosphate), citrates (acetyl tributyl citrate), sebacates, azelates, maleates, benzoates, polyether polyesters, epoxypolyesters (epoxidazed soybean oil, epoxidazed linseed oil), polyesters (low molecular polyesters made of carboxylic acid and glycol). These can be used alone or as mixture of two or more.

Among these, ester plasticizing agents are preferable.

The plasticizing agent may be suitably added in an amount of about 10 to about 60 parts by weight, and preferably about 10 to about 30 parts by weight relative to 100 parts by weight of a thermoplastic resin.

There is no particular limitation in relation to the stabilizer, and the stabilizer may include a barium-zinc based, a tin based, a calcium-zinc based, or a cadmium-barium based composite stabilizing agent, or the like.

The filler includes an inorganic filler such as calcium carbonate, silica, mica or the like, or a metal filler such as iron, lead or the like.

The colorant includes a pigment, a dye or the like.

Other additives include use of any additive known for use in this field.

The thermoplastic resin film may be a single-layer film, or may be a laminated film (multilayer film) exhibiting the advantages of respective resins including different materials or compositions.

The thickness of the thermoplastic resin film may be adjusted in relation to the physical properties of the target adhesive tape or the like, and for example may fall within a range of about 30 to about 1000 μm, preferably about 40 to about 800 μm, more, preferably about 50 to about 500 μm, and further more preferably about 50 to about 200 μm.

The front and rear surfaces of the thermoplastic resin film, and in particular, the front surface, that is to say, the surface on the side provided with the adhesive layer, may be processed using a customary surface processing method, such as an oxidizing process or the like using a chemical or physical method such as corona processing, chromic acid processing, ozone exposure, exposure to a flame, exposure to high-voltage electric shock, ion irradiation processing, or the like in order to improve the adhesion with the adhesive agent.

### (Pressure Sensitive Adhesive Layer)

The pressure sensitive adhesive (hereinafter may be simply referred to as “adhesive”) layer is formed from a pressure sensitive adhesive. There is no particular limitation in relation to the pressure sensitive adhesive, and for example a rubber adhesive, an acrylic adhesive, a polyamide adhesive, a silicone adhesive, a polyester adhesive, a polyurethane adhesive or the like may be used depending on the type of base polymer that forms the adhesive. Suitable selection may be made from such known adhesives. Of such adhesives, suitable use for the expression of desired characteristics may be enabled by selection of the type of monomer component that configures the acrylic polymer and exhibits superior performance in relation to various characteristics such as heat resistance, weather resistance or the like.

The acrylic adhesive is usually formed by a base polymer made from a main monomer component such as (meth)acrylic alkyl ester.

Examples of the (meth)acrylic alkyl ester include a C1 to C20 (preferably C1 to C12, and more preferably C1 to C8) alkyl(meth)acrylate such as methyl(meth)acrylate, ethyl(meth)acrylate, propyl(meth)acrylate, isopropyl(meth)acrylate, butyl(meth)acrylate, isobutyl(meth)acrylate, sec-butyl(meth)acrylate, tert-butyl(meth)acrylate, pentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, octadecyl(meth)acrylate, nonadecyl(meth)acrylate, eicosyl(meth)acrylate. The (meth)acrylic alkyl ester can be used alone or as mixture of two or more (meth)acrylic alkylesters.

The acrylic polymer may be a copolymer that is copolymerized with the (meth)acrylic alkyl ester and another copolymerizable monomer, as needed, for the purpose of modifying the cohesive force, heat resistance, cross linking property and the like.

Examples of such another monomer include;

a carboxyl-containing monomer such as (meth)acrylic acid, carboxyethyl(meth)acrylate, carboxypentyl(meth)acrylate, itaconic acid, maleic acid, fumaric acid, crotonic acid;

a hydroxyl group-containing monomer such as hydroxybutyl(meth)acrylate, hydroxyhexyl(meth)acrylate, hydroxyoctyl(meth)acrylate, hydroxydecyl(meth)acrylate, hydroxylauryl(meth)acrylate, (4-hydroxymethyl cyclohexyl)methyl(meth)acrylate;

a sulfonate-containing monomer such as styrenesulfonate, allylsulfonate, 2-(meth)acrylamide-2-methyl propanesulfonate, (meth)acrylamide propanesulfonate, sulfopropyl(meth)acrylate, (meth)acryloyl oxynaphthalenesulfonate;

a phosphate-containing monomer such as 2-hydroxyethyl acryloylphosphate;

an N-substituted amide monomer such as (meth)acrylic amide, N,N-dimethyl(meth)acrylic amide, N-butyl(meth)acrylic amide, N-methylol(meth)acrylic amide, N-metilolpropane(meth)acrylic amide;

an aminoalkyl(meth)acrylic monomer such as amino ethyl(meth)acrylate, N,N-dimethyl amino ethyl(meth)acrylate, t-buthylaminoethyl(meth)acrylate;

an alkoxy alkyl(meth)acrylic monomer;

maleimide monomer such as N-cyclohexylmaleimide, N-isopropylmaleimide, N-raurylmaleimide, N-phenylmaleimide;

an itaconimide monomer such as N-methyl itaconimide, N-ethyl itaconimide, N-butyl itaconimide, N-octyl itaconimide, N-2-ethylhexyl itaconimide, N-cyclohexyl itaconimide, N-rauryl itaconimide;

a succinimide monomer such as N-(meth)acryloyloxymethylene succinimide, N-(meth)acryloyl-6-oxy hexamethylene succinimide, N-(meth)acryloyl-8-oxy octamethylene succinimide;

a vinyl monomer such as vinyl acetate, vinyl propionate, N-vinyl pyrrolidone, methyl vinyl pyrrolidone, vinyl pyridine, vinyl piperidone, vinyl pyrimidine, vinyl piperadine, vinyl pyrazin, vinyl pyrrole, vinyl imidazole, vinyl oxazole, vinyl morpholine, N-vinyl carboxylic acid amide, styrene, α-methylstyrene, N-vinyl caprolactam;

a cyano acrylate monomer such as acrylonitrile, methacrylonitrile;

an epoxy-containing acrylic monomer such as glycidyl(meth)acrylate;

a glycol acrylate monomer such as polypropylene glycol(meth)acrylate, methoxyethylene glycol(meth)acrylate, methoxypolypropylene(meth)acrylate;

a heterocyclic-, halogen atom-, silicon-containing (meth)acrylate such as tetrahydro furfuryl(meth)acrylate, fluoro(meth)acrylate, silicon(meth)acrylate;

a multifunctional monomer such as hexanediol di(meth)acrylate, polyethylene glycol di(meth)acrylate, polypropylene glycol di(meth)acrylate, neopentylglycol di(meth)acrylate, pentaerythritol di(meth)acrylate, trimethylolpropane tri(meth)acrylate, pentaerythritol tri(meth)acrylate, dipentaerythritol hexa(meth)acrylate, epoxy(meth)acrylate, polyester(meth)acrylate, urethane(meth)acrylate, divinylbenzene, butyldi(meth)acrylate, hexyldi(meth)acrylate;

an olefine monomer such as isoprene, dibutadiene, isobutylene;

a vinyl ether monomer such as vinyl ether.

These monomers can be used alone or as mixture of two or more monomers.

The acrylate copolymer can be produced by a conventional polymerization method with the above (meth)acrylic alkyl ester and other monomer as needed.

There is no particular limitation in relation to the molecular weight of the acrylic copolymer, for example, the weight average molecular weight of the acrylic copolymer to be about 100,000 to about 2,000,000, about 150,000 to 1,000,000 is preferable, and about 300,000 to 1,000,000 is more preferable. The weight average molecular weight of the polymer can be found by gel permeation chromatography (GPC).

The adhesive may be configured as an energy-ray curable adhesive by adding an energy-ray polymerizable compound, or by introducing an energy-ray polymerizable double bonds into the base polymer. The adhesive layer that uses the energy-ray curable adhesive realizes sufficient adhesion before irradiation with energy rays. Also, there is the possibility of a conspicuous reduction in adhesion after irradiation with energy rays to thereby facilitate peeling without application of a stress to the adherend. The energy rays include for example ultraviolet rays, electron rays, or the like.

The energy-ray polymerizable compound includes a compound that has at least two energy-ray polymerizable carbon-carbon double bonds per molecule. The compound includes for example a multifunctional acrylate compound.

Examples of the multifunctional acrylate compound include;

a 1,4-butylenedi(meth)acrylate;

a linear aliphatic polyol(meth)acrylate such as 1,4-butylenediol di(meth)acrylate, 1,5-pentanediol di(meth)acrylate, 1,6-hexhandiol di(meth)acrylate, 1,9-nonanediol di(meth)acrylate, polyethylene glycol di(meth)acrylate, polypropylene glycol di(meth)acrylate;

a cyclic aliphatic polyol(meth)acrylate such as cyclohexane dimethanol di(meth)acrylate, tricyclodecane dimethanol di(meth)acrylate;

a branched chain aliphatic polyol(meth)acrylate such as trimethylolpropane tri(meth)acrylate, pentaerythritol tri(meth)acrylate, pentaerythritol tetra(meth)acrylate;

a condensed compound thereof.

These compounds can be used alone or as mixture of two or more compounds.

The multifunctional acrylate oligomer such as urethane(meth)acrylate oligomers can be used as the energy-ray polymerizable compound.

Urethane(meth)acrylate oligomer can be produced by reacting a hydroxy group-containing alkyl(meth)acrylic acid compound with urethane oligomer which is obtained by reacting diisocyanate with polyol compound.

Examples of diisocyanate include tolylenediisocyanate, diphenylmethane diisocyanate, hexamethylene diisocyanate, phenylene diisocyanate, dicyclohexylmethane diisocyanate, xylene diisocyanate, tetramethylxylene diisocyanate, naphthalene diisocyanate, isophorone diisocyanate.

Examples of polyol include a polyol such as ethylene glycol, propylene glycol, 1,4-butanediol, 1,6-hexanediol, diethylene glycol, trimethylolpropane, dipropylene glycol, polyethylene glycol, polypropylene glycol, pentaerythritol, dipentaerythritol, glycerin;

a polyester polyol obtained by condensation reaction of the above polyol and an aliphatic dicarboxylic acid (e.g., adipic acid, sebacic acid, azelaic acid, maleic acid) or aromatic dicarboxylic acid (e.g., terephthalic acid, isophthalic acid);

a poly ether polyol such as polyethylene ether glycol, polypropylene ether glycol, polytetramethylene ether glycol, polyhexamethylene ether glycol;

a lactone polyol such as polycaprolactone glycol, polypropiolactone glycol, polyvalerolactone glycol;

a polycarbonate polyol compound obtained by dealcohol reaction of a polyol (e.g., ethylene glycol, propylene glycol, butanediol, pentanediol, octandiol, nonandiol) and a diethylene carbonate, dipropylene carbonate, or the like.

Examples of hydroxy group-containing (meth)acrylate alkyl ester include 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, (4-hydroxymethylcyclohexyl(meth)acrylate.

The energy-ray polymerizable compound may be suitably used in an amount of about 5 to about 200 parts by weight, preferably about 10 to about 100 parts by weight, and more preferably about 10 to about 45 parts by weight relative to 100 parts by weight of a base polymer.

The method of introducing energy-ray polymerizable double bonds into the base polymer includes for example a method in which a copolymerizable monomer including a reactive functional group such as a carboxyl group, a hydroxyl group, an amino group, or the like is subjected to copolymerization when preparing the acrylic polymer that forms the base polymer. In this manner, the functional group forming the base of the reaction can be introduced into the base polymer, and a functional monomer or an oligomer that includes energy-ray polymerizable carbon-carbon double bonds can be bonded through the functional group that forms the basis of the reaction. As a result, a base polymer can be obtained that includes energy-ray polymerizable carbon-carbon double bonds in a side chain.

The energy-ray curable adhesive may include a photopolymerization initiator as required. The photopolymerization initiator is excited and activated by irradiation with energy rays to form radicals and thereby promote an effective polymerization curing reaction in the adhesive layer.

Examples of the photopolymerization initiator include, for example,

a benzoine alkyleter photopolymerization initiator such as benzoine methyl ether, benzoine ethyl ether, benzoine isopropyl ether and benzoine isobutyl ether;

a benzophenone photopolymerization initiator such as benzophenone, benzoylbenzoate, 3,3′-dimethyl-4-methoxy benzophenone, polyvinyl benzophenone;

an aromatic ketone photopolymerization initiator such as α-hydroxy cyclohexylphenyl kethone, 4-(2-hydroxyethoxy)phenyl(2-hydroxy-2-propyl) ketone, α-hydroxy-α,α′-dimethylacetophenone, 2,2-dimethyl-2-phenylacetophenone and 2,2-diethoxy acetophenone;

an aromatic ketal photopolymerization initiator such as benzyldimethyl ketal;

a thioxanthone photopolymerization initiator such as thioxanthone, 2-chlorothioxanthone, 2-methylthioxanthone, 2-ethylthioxanthone, 2-isopuropylthioxanthone, 2-dodecylthioxanthone, 2,4-dichlorothioxanthone, 2,4-dimethylthioxanthone, 2,4-diethylthioxanthone and 2,4-diisopropylthioxanthone;

a benzoyl photopolymerization initiator such as benzyl;

a benzoin photopolymerization initiator such as benzoin;

an α-ketol photopolymerization initiator such as 2-methyl-2-hydroxypuropiophenone;

an aromatic sulfonyl chloride photopolymerization initiator such as 2-naphthalene sulfonyl chloride;

a light-active oxime photopolymerization initiator such as 1-phenon-1,1-propanedione-2-(o-ethoxycarbonyl)oxime;

a specialized photopolymerization initiator such as α-acyloxim ester, methylphenyl glyoxylate, benzyl,

camphor quinine, ketone halide, acyl phosphinoxide and acyl phosphonate.

These compounds can be used alone or as mixture of two or more compounds.

The adhesive may include a polymer that has an acidic group such as a carboxyl group as a base polymer, and may include a hydrophilic adhesive that is imparted with hydrophilic properties by neutralization of all or a part of the acidic groups in the base polymer by addition of a neutralizing agent. The hydrophilic adhesive generally exhibits low residual glue on the adherend, and even in the event that residual glue is present, simple removal by washing in pure water is possible.

When preparing the base polymer, a polymer that includes an acidic group can be obtained by polymerization of monomers that have acidic groups such as a monomer that contains a carboxyl group as described above.

Examples of the neutralizing agent include a primary amine such as monoethylamine, monoethanolamine; a secondary amine such as diethylamine diethanolamine; a tertiary amine such as triethylamine triethanolamine, N,N,N′-trimethyl ethylenediamine, N-methyldiethanolamine, N,N-diethylhydroxylamine, an organic amino compound with alkalinity.

The adhesive may contain a cross linking agent as required.

Examples of the cross linking agent include an epoxy-based cross linking agent, an isocyanate-based cross linking agent, a melamine-based cross linking agent, a peroxide-based cross linking agent, a metal alkoxide-based cross linking agent, a metal chelate-based cross linking agent, a metal salt-based cross linking agent, a carbodiimide-based cross linking agent, an oxazoline-based cross linking agent, an aziridine-based cross linking agent, an amine-based cross linking agent, and the epoxy-based cross linking agent and isocyanate-based cross linking agent are preferable. These compounds can be used alone or as mixture of two or more compounds.

Examples of the epoxy-based cross linking agernt include, for example, N,N,N′,N′-tetraglycidyl-m-xylenediamine, diglycidylaniline, 1,3-bis(N,N-glycidylaminomethyl)cyclohexane, 1,6-hexandioldiglycidyleter, neopentyl glycol diglycidyleter, ethylene glycol diglycidyleter, propylene glycol diglycidyleter, polyethylene glycol diglycidyleter, polypropylene glycol diglycidyleter, sorbitol polyglycidyl ether, glycerol polyglycidyl ether, pentaerythritol polyglycidyl ether, polyglycerol polyglycidyl ether, sorbitane polyglycidyl ether, trimethylolpropane polyglycidyl ether, diglycidyl adipate, diglycidyl o-phthalate, triglycidyl-tris(2-hydroxyethyl)isocyanurate, resorcin diglycidyl eter, bisphenol-5-diglycidyl eter, epoxy resin which has 2 or more epoxy group in its molecule.

Examples of the isocyanate-based cross linking agent include, for example, lower aliphatic polyisocyanates such as 1,2-ethylene diisocyanate, 1,4-butylene diisocyanate, 1,6-hexamethylene diisocyanate; aliphatic polyisocyanates such as cyclopentylene diisocyanate, cyclohexylene diisocyanate, isophorone diisocyanate, hydrogenation trilene diisocyanate, hydrogenation xylene diisocyanate; aromatic polyisocyanates such as 2,4-trilene diisocyanate, 2,6-trilene diisocyanate, 4,4′-diphenyl methane diisocyanate, xylylene diisocyanate.

The adhesive layer preferably contains a plasticizing agent. The plasticizing agent may be the same as those described above. The added amount of the plasticizing agent may be suitably determined using a proportion of about 10 to about 100 parts by weight, preferably about 10 to about 80 parts by weight, and more preferably about 10 to about 60 parts by weight relative to 100 parts by weight of a thermoplastic resin that configures the adhesive, that is to say, the base polymer.

The adhesive layer may also include an additive such as a stabilizer, a filler/lubricant, a colorant, a UV absorbing agent, an antioxidant, a dye or the like as required. These additives may be the same as those described above.

The adhesive layer may be formed by applying the adhesive described above onto a base material using a suitable method such as knife coating, roller coating, gravure coating, die coating, reverse coating, or the like. For example, an adhesive layer may be formed on a suitable casting process sheet such as a film surface processed using a mold release process, and then the adhesive layer may be transferred onto the thermoplastic film.

There is no particular limitation in respect of the thickness of the adhesive layer. A thickness of about 5 to about 100 μm is preferred, more preferably about 5 to about 60 μm, and in particular preferably about 5 to about 30 μm. When the thickness of the adhesive layer is within the above range, the stress applied to the thermoplastic resin film can be reduced, and it is possible to improve the stress relaxation rate of the adhesive tape.

### (Fatty Acid Bisamide, Fatty Acid Monoamide, and Fatty Acid)

At least one of the thermoplastic resin film and the pressure sensitive adhesive layer described above contains a fatty acid bisamide as well as a fatty acid monoamide and/or a fatty acid, i.e., at least one of the thermoplastic resin film and the pressure sensitive adhesive layer described above contains a fatty acid bisamide and a fatty acid monoamide; or a fatty acid bisamide and a fatty acid; or a fatty acid bisamide, a fatty acid monoamide and a fatty acid. The fatty acid bisamide as well as the fatty acid monoamide and/or the fatty acid may be contained in both of the thermoplastic film and the pressure sensitive adhesive layer. The thermoplastic film and/or the pressure sensitive adhesive layer may have a laminated structure, and when the fatty acid bisamide as well as the fatty acid monoamide and/or the fatty acid are contained in the thermoplastic film and/or the pressure sensitive adhesive layer, the fatty acid bisamide as well as the fatty acid monoamide and/or the fatty acid may be contained in all layers of the laminated structure. However, the compounds are preferably contained at least in a layer in which that the thermoplastic film and the pressure sensitive adhesive layer are in mutual contact. In this manner, effective prevention of an uneven distribution of the fatty acid bisamide in the layers is possible.

The fatty acid bisamide may be a compound represented by the formula (II) or the formula (III). These compounds can be used alone or as mixture of two or more compounds.

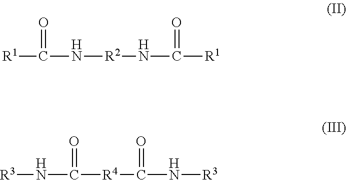

wherein, R¹ and R³ independently represent a C6 to C23 saturated or unsaturated aliphatic hydrocarbon group, R² and R⁴ independently represent a divalent C1 to C12 saturated or unsaturated aliphatic hydrocarbon group or a C6 to C12 aromatic hydrocarbon group.

The saturated aliphatic hydrocarbon group includes linear, branched chain, cyclic and a combination thereof.

Examples of the saturated aliphatic hydrocarbon group include an alkyl group such as methyl, ethyl, propyl, isopropyl, n-butyl, sec-butyl, t-butyl, pentyl, hexyl, octyl, decyl, dodecyl, tetoradecyl, hexadecyl, octadecyl; a branched chain alkyl group such as ethylhexyl, ethyloctyl, propylhexyl; a cyclic alkyl group such as cyclopentyl, cyclohexyl, cycloheptyl, and the like.

Examples of the unsaturated aliphatic hydrocarbon group include a propenyl, isopropenyl, 2-propenyl, 9-octadecenyl group, cyclopentenyl, cyclohexenyl and the like.

Examples of the aromatic hydrocarbon group include a non-substituted aryl group such as a phenyl, naphtyl; alkyl-substituted phenyl group such as tryl, dimethylphenyl, ethyl phenyl, butylpehnyl, t-butylphenyl, dimethylnaphtyl, and the like.

In the formula (II) and the formula (III), R² and R⁴ are independently preferably a divalent C1 to C6 saturated or unsaturated aliphatic hydrocarbon group, and more preferably a divalent C1 to C6 saturated aliphatic hydrocarbon group.

Among these, the compound represented by the formula (II) is preferable.

Examples of the compound represented by the formula (II) include N,N′-methylene bisstearic acid amide, N,N′-ethylene bislauric acid amide, N,N′-ethylene bisstearic acid amide, N,N′-ethylene bisoleic acid amide, N,N′-ethylene bisbehenic acid amide, N,N′-ethylene biserucic acid amide, N,N′-butylene bisstearic acid amide, N,N′-hexamethylene bisstearic acid amide, N,N′-hexamethylene bisoleic acid amide, and N,N′-xylene bisstearic acid amide, and the like.

Examples of the compound represented by the formula (III) include N,N′-dioleyl adipic acid amide, N,N′-distearyl adipic acid amide, N,N′-dioleyl sebacic acid amide, N,N′-distearyl sebacic acid amide, N,N′-distearyl terephthalic acid amide, and N,N′-distearyl isophthalic acid amide, and the like.

Among these, N,N′-methylene bisstearic acid amide, N,N′-ethylene bislauric acid amide, N,N′-dioleyl adipic acid amide, and N,N′-ethylene biserucic acid amide are preferable.

The fatty acid monoamide may be a compound represented by the formula (I). These compounds can be used alone or as mixture of two or more compounds.

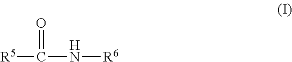

wherein, R⁵ represents a C6 to C23 saturated or unsaturated aliphatic hydrocarbon group, and R⁶ represents a hydrogen atom or a C6 to C23 saturated or unsaturated aliphatic hydrocarbon group.

A compound wherein R⁶ is a hydrogen atom is preferable in the formula (I).

Examples of the compound represented by the formula (I) include lauric acid amide, stearic acid amide, olein acid amide, erucic acid amide, laurylic acid amide, recinoleic acid amide, palmitic acid amide, myristic acid amide, behenic acid amide;

N-oleylstearic acid amide, N-oleylolein acid amide, N-stearylstearic acid amide, N-stearylolein acid amide, N-oleylpalmitic acid amide, N-stearyl erucic acid amide, and the like.

Among these, stearic acid amide is preferable.

The fatty acid may be a compound represented by the formula (IV). These compounds can be used alone or as mixture of two or more compounds.

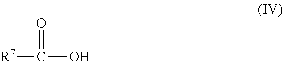

wherein, R⁷ represents a C6 to C23 saturated or unsaturated aliphatic hydrocarbon group.

Examples of the fatty acid represented by the formula (IV) include lauric acid, stearic acid, olein acid, erucic acid, laurylic acid, recinoleic acid, palmitic acid, myristic acid, behenic acid, and the like. Among these, stearic acid, olein acid, and palmitic acid are preferable.

Thus, crystal growth of the fatty acid bisamide at a normal temperature in the adhesive tape that is provided with a release liner can be prevented by including the fatty acid bisamide as well as the fatty acid monoamide and/or the fatty acid in the thermoplastic film and/or the pressure sensitive adhesive layer. In addition, there was the new insight that subsequent crystallization of fatty acid bisamide may be promoted when stored at 60° C. In this manner, fatty acid bisamide that does not crystallize under normal production conditions can be purposely produced, and therefore it is possible to ensure prevention of an increase in adhesion during storage when applied to an adherend. Furthermore, when storing at 60° C., with a release liner attached, fatty acid bisamide can be crystallized on the adhesive surface, and suppression of a reduction in the adhesion force can be ensured by causing non-uniformity in the existence sites of the fatty acid bisamide.

Furthermore, when adhering to an adherend and storing at a high temperature, since the fatty acid bisamide migrates from the adhesive surface to an inner portion, although the adhesion force increases, the addition of fatty acid monoamide and/or a fatty acid means that both components remain in a suitably compatibility, and migration of both components is suppressed to a minimum. Therefore a balance can be created in the distribution of each component in the thermoplastic resin film and in the adhesive layer, and the adhesive characteristics can be stabilized.

There is no particular limitation in respect of the combination of fatty acid bisamide contained as well as the fatty acid monoamide and/or the fatty acid in the thermoplastic film and/or the pressure sensitive adhesive layer, a combination containing a hydrocarbon group that is common to both components is preferred from a point of view of compatibility.

The added amount of fatty acid bisamide in the thermoplastic resin film is preferably about 0.1 to about 3.0 parts by weight relative to 100 parts by weight of thermoplastic resin in the thermoplastic resin film. Even when adding to the pressure sensitive adhesive layer, suitable adjustment within a range of about 0.1 to about 3.0 parts by weight relative to 100 parts by weight of the thermoplastic resin is preferred.

When the fatty acid bisamide is added to both of the thermoplastic film and the pressure sensitive adhesive layer, it is preferred that the total added amount is suitably adjusted within a range of about 0.1 to about 3.0 parts by weight relative to 100 parts by weight of thermoplastic resin.

The fatty acid monoamide and/or the fatty acid may be added to at least one of the thermoplastic film and the pressure sensitive adhesive layer, and total amount of the fatty acid monoamide and/or the fatty acid is preferably about 0.1 to about 20.0 parts by weight relative to 100 parts by weight of fatty acid bisamide.

### (Release Liner)

The release liner may be a commonly used liner in this technical field, and may be used without any particular limitation thereon. For example, a base such as a film formed from paper; rubber; various foils such as aluminum foil, copper foil, stenless steel foil, iron foil, duralumin fiol, tin foil, titanium foil, gold foil; film made of various resins such as polyethylene, polypropylene, polyvinyl chloride, polyester, polyamide; foams such polyurethane foam, vinyl foam, polyethylene foam, stylene foam; nonwoven fabric; woven fabric; felt, or a laminate of these materials with a polymer material may be used as a base material.

There is no particular limitation on the thickness of the base material, it suitably falls within a range of about 5 μm to about 5 mm, and preferably about 30 μm to about 100 μm.

The surface on the side that comes into contact with the adhesive layer in this type of base material may be die release treated by a known method in this technical field, which includes laminate coating of a die release agent such as a silicone-based resin, a long-chain alkyl-based resin, fluorine-based resin, low molecular weight polyethylene, polypropylene, a rubber-based polymer and a phosphate ester-based surface active agent, and the like.

The release liner may include one or a plurality of slits (in a so-called back cut configuration) that have a linear, waved, serrated or saw toothed shape to improve the adhesive operation performance when adhereing the adhesive tape to an adherend.

### (Method of Manufacture of Adhesive Tape)

The thermoplastic resin film and the pressure sensitive adhesive layer of the adhesive tape according to the present invention may be formed separately by using a method that is known in this technical field. For this purpose, for example, a method such as a melt extrusion molding method (an inflation method, a T die method, or the like), a melt casting method, a calendar method or the like may be used. The adhesive layer may be separately formed using the above methods. When the thermoplastic resin film and the pressure sensitive adhesive layer are formed separately, both layers may be laminated using a method that is known in this technical field. Furthermore, the thermoplastic resin film and the pressure sensitive adhesive layer may be formed as a multilayer structure by a co-extrusion method, a laminating method (extrusion lamination method, a lamination method using an adhesive or the like), and a heat seal method (external heating method, internal heating method, or the like).

An adhesive tape including a release liner is normally obtained by bonding the release liner to the side provided with the adhesive layer after forming the adhesive tape.

### (Adhesive Tape)

The adhesive tape according to the present invention is preferably a tape that suppresses a stainless plate adhesive force to a variation within ±50% of an initial value before and after storage irrespective of the storage conditions. In this range, a reduction of the adhesive force of the adhesive tape or sheet can be prevented irrespective of the storage conditions, and thereby it is possible to facilitate release from the adherend. As used herein, “before storage” means immediately after manufacture of the adhesive tape, and attachment of the release liner to the side provided with the adhesive layer. “After storage” normally means a point in time of approximately one week after attachment of the release liner to the side provided with the adhesive layer.

The adhesive tape may be used for various applications. Examples of the application may include an adhesive tape for fixing of wafers during semiconductor processing, of various members of products having a plate shape or curved surface formed from resin, glass, metal or the like, of film or optical devices; for back-grinding of semiconductors; for dicing of semiconductors; for dicing of semiconductor packages, glass, ceramics, or the like; or for protection of circuit surfaces during such processes.

In this manner, the adhesive tape according to the present invention obtains a constant sufficient adhesive force irrespective of the storage conditions, that is to say, during storage or processing at a high temperature, by mixing of a fatty acid monoamide and/or a fatty acid as well as a fatty acid bisamide in a suitable balance in a film or layer. Furthermore, when re-peeling from an adherend under storage conditions after adhering to an adherend, a disadvantage such as difficulty of peeling due to increased adhesive strength or adhesive remaining on the adherend can be prevented.

### EXAMPLES

The adhesive tape of the present invention will now be described in detail on the basis of examples. All parts and percentages in the examples and comparative examples are by weight unless otherwise indicated.

A composition was prepared by blending components as described below in a Henschel mixer, impregnating a plasticizer into the resin, and drying. This composition was kneaded in a Banbury mixer to mix a polyvinyl chloride, and then a thermoplastic resin film having a thickness of 70 μm was formed with the obtained composition and using a calendar film-forming apparatus.

Fatty acid bisamide as well as fatty acid monoamide and/or a fatty acid were added during kneading using the Banbury mixer according to the proportions stated in the Examples and the Comparative Examples.

| Thermoplastic resin: polyvinyl chloride resin | 100 | parts by weight |
|---|---|---|
| (average degree of polymerization 1050) | | |
| Plasticizer: Diethylhexyl phthalate | 30 | parts by weight |
| Stabilizer: Ba-Zn mixed stabilizer | 3 | parts by weight |
| Methylene bisstearic acid amide | 0.68 | parts by weight |
| (bisamide LA, Nippon Kasei Co., Ltd.) | | |
| Stearic acid (NAA-180, NOF Corporation) | 0.02 | parts by weight |

The adhesive composition was prepared with the following composition.

| Acrylic polymer | 100 | parts by weight |
|---|---|---|
| (butyl acrylate/acrylonitrile/acrylic acid = 84/14/2) | | |
| Plasticizer: diethylhexyl phthalate | 20 | parts by weight |
| Cross linking agent: butylated melamine resin | 10 | parts by weight |

The resulting adhesive resin composition was diluted to 20% with toluene, and applied on the thermoplastic resin film described above to obtain a thickness of 10 μm after drying. An adhesive tape rolled into a roll-shape was obtained after passing through a drying step for one minute at 150° C.

Then aging was executed for 24 hours at 50° C., and then the adhesive layer adhered to a release liner and rolled with the release liner (silicone processed polyester film, MRF, 38 μm (Mitsubishi Plastics)).

The following evaluation was performed using the resulting adhesive tape.

(1) Evaluation of Adhesion Force of Tape after Heating and Storing

After storage of the adhesive tape with the release liner attached for one week in a drier at 60° C., test pieces were cut into a length of 100 mm and a width of 20 mm after leaving the tape for one hour at room temperature, and then the adhesive force was measured under the following conditions.

Measurement Apparatus: instron tensile test apparatus AUTOGRAPH AG-IS Shimadzu Corporation

Measurement Conditions: 23° C., 50% RH

Adherend: stainless steel plate (SUS430BA)

Adherend Washing Condition: toluene immersion, ultrasonic cleaning, 30 min

Bonding Conditions: linear pressure 78.5 N/cm, speed 0.3 m/min

Measurement Conditions: 180° peel, 300 mm/min

Acceptability Determination Pass grade for values within ±50% of initial value

(2) Evaluation of Adhesion Force after Bonding to Stainless Steel Plate and Heated-Storing

Test pieces having a length of 100 mm and a width of 20 mm were bonded to a stainless steel plate, and the adhesive force was measured under the following conditions for a product left for one hour at room temperature after leaving the pieces for one week in a drier at 60° C.

Measurement Apparatus: instron tensile test apparatus AUTOGRAPH AG-IS Shimadzu Corporation

Measurement Conditions: 23° C., 50% RH

Adherend: stainless steel plate (SUS430BA)

Adherend Washing Condition: toluene immersion, ultrasonic cleaning, 30 min

Bonding Conditions: linear pressure 78.5 N/cm, speed 0.3 m/min

Measurement Conditions: 180° peel, 300 mm/min

Acceptability Determination Pass grade for values within ±50% of initial value.

In contrast to the Examples above, the adhesive tape in the Comparative Examples was prepared with the addition of only fatty acid bisamide and without the addition of a fatty acid, and evaluated in the same manner as the Examples.

The results are shown in Table 1 in relation to compositions (units: parts by weight) of fatty acid monoamide and/or fatty acids, fatty acid bisamide.

TABLE 1

| | | Example | | | Comp. Ex. | |
|---|---|---|---|---|---|---|
| | | 1 | 2 | 3 | 1 | 2 |
| Fatty acid bisamide | | 0.68 | 0.57 | 0.57 | 0.3 | 0.6 |
| (Methylene bisstearic acid amide) | | | | | | |
| Fatty acid monoamide | | | | 0.03 | | |
| (Stearic acid amide) | | | | | | |
| Fatty acid (Palmitic Acid) | | | 0.03 | | | |
| Fatty acid (Stearic Acid) | | 0.02 | | | | |
| Evaluation | Initial | 1.20 | 1.14 | 0.94 | 1.24 | 1.08 |
| (N/20 mm) | Adhesion Force after | 0.90 | 0.97 | 0.82 | 0.76 | 0.49 |
| | Storing | | | | | |
| | Adhesion Force | 1.63 | 1.64 | 1.32 | 2.16 | 2.35 |
| | after Bonding & | | | | | |
| | Storing | | | | | |

| | | | | | |
|---|---|---|---|---|---|
| Determination | ∘ | ∘ | ∘ | x | x |

The fatty acid monoamide and/or fatty acids as well as fatty acid bisamide in the Table 1 are bellow.

Fatty Acid Bisamide:

Methylene bisstearic acid amide (bisamide LA, Nippon Kasei Co., Ltd.)

Fatty Acid Monoamide:

Stearic acid amide (Daiyamid 200, Nippon Kasei Co., Ltd.)

Fatty Acids:

Palmitic acid (NAA-160, NOF Corporation)

Stearic acid (NAA-180, NOF Corporation)

The adhesive tape according to the present invention enables use in a wide range of application as a processing or protective sheet or the like during dicing, or as a sheet for surface protection of various adherends including electronic components.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. An adhesive tape or sheet with a release liner comprising;
a thermoplastic resin film,
a pressure sensitive adhesive layer formed on one side of the thermoplastic resin film, and
a release liner positioned on one side of the pressure sensitive adhesive layer,
a fatty acid bisamide as well as a fatty acid monoamide and/or fatty acid are contained at least one of the thermoplastic resin film and the pressure sensitive adhesive layer.

2. The adhesive tape or sheet with a release liner of claim 1, wherein the fatty acid bisamide is a compound represented by the formula (II) or the formula (III). 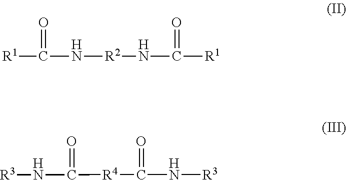
wherein, R¹ and R³ independently represent a C6 to C23 saturated or unsaturated aliphatic hydrocarbon group, R² and R⁴ independently represent a divalent C1 to C12 saturated or unsaturated aliphatic hydrocarbon group or a C6 to C12 aromatic hydrocarbon group.

3. The adhesive tape or sheet with a release liner of claim 1, wherein the fatty acid monoamide is a compound represented by the formula (I). 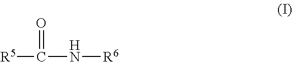
wherein, R⁵ represents a C6 to C23 saturated or unsaturated aliphatic hydrocarbon group, and R⁶ represents a hydrogen atom or a C6 to C23 saturated or unsaturated aliphatic hydrocarbon group.

4. The adhesive tape or sheet with a release liner of claim 1, wherein the fatty acid is a compound represented by the formula (IV). 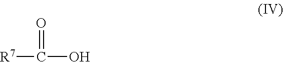
wherein, R⁷ represents a C6 to C23 saturated or unsaturated aliphatic hydrocarbon group.

5. The adhesive tape or sheet with a release liner of claim 1, wherein the fatty acid bisamide is contained in an amount of 0.1 to 3.0 parts by weight relative to 100 parts by weight a thermoplastic resin.

6. The adhesive tape or sheet with a release liner of claim 1, wherein the fatty acid monoamide and/or fatty acid is contained in an amount of 0.1 to 20.0 parts by weight relative to 100 parts by weight a fatty acid bisamide.

7. The adhesive tape or sheet with a release liner of claim 1, wherein the thermoplastic resin film is a film made of polyvinyl chloride-based resin.

8. The adhesive tape or sheet with a release liner of claim 1, wherein the thermoplastic resin film further contains an ester plasticizing agent.

9. The adhesive tape or sheet with a release liner of claim 1, wherein the pressure sensitive adhesive contains an acrylic polymer as a base polymer.

10. The adhesive tape or sheet with a release liner of claim 1, wherein the pressure sensitive adhesive further contains an ester plasticizing agent.

11. The adhesive tape or sheet with a release liner of claim 1, wherein one side of the pressure sensitive adhesive layer of the release liner is treated with a silicone polymer.

12. The adhesive tape or sheet with a release liner of claim 1, wherein the adhesive layer has a stainless plate adhesive force to a variation within ±50% of an initial value after storage.
